(19) United States
(12) Patent Application Publication
(10) Pub. No.: US 2005/0073732 A1
(43) Pub. Date: Apr. 7, 2005

(54) Systems and methods for scanning media

(76) Inventors: Jordi Arnabat Benedicto, L'Arboc del Penedes (ES); Oscar Martinez Bailac, Barcelona (ES); Steven John Simske, Ft. Collins, CO (US); Roland John Burns, Ft. Collins, CO (US)

Correspondence Address: HEWLETT-PACKARD COMPANY;Intellectual Property Administration, P.O. Box 272400, Fort Collins, CO, 80527-2400, US

(21) Appl. No.: 10/676,392

(22) Filed: Oct. 1, 2003

(51) Int. Cl. G06K 1/00; H04N 1/04

(52) U.S. Cl. 358/527; 358/474; 358/1.2

(57) ABSTRACT

Disclosed are systems and methods for scanning media. In one embodiment, a system and a method pertain to scanning a platen at a relatively low resolution using a dedicated preview image sensor, and pre-processing image data obtained through the scanning of the platen to automatically determine settings to apply during a subsequent final scan.

### BACKGROUND

Several peripheral and walk-up devices have scanning capabilities so that hard copy documents or electronic image files can be created from existing media (text and/or graphics documents, photographs, etc.). For example, scanners, photocopiers, and multifunction peripheral (MFP) devices are each capable of scanning such media.

Today various initial processing is often performed on scanned image data to automatically determine various scanning settings to be implemented during a final scan of the media. For instance, processing related to automatic copy type detection (black and white versus color), automatic document size detection, automatic skew detection, zoning analysis, and so forth may be performed. From the information gleaned from that processing, higher quality results can be obtained, often in less time. For example, if the user wishes to scan a 4 inch by 6 inch photograph initial, processing can be used to limit the area of the platen that is scanned at high-resolution.

Current processes for processing scanned image data have attendant disadvantages including the length of time required to complete such processing. Therefore, desirable would be a system and method for effectively scanning media with reduced processing time to accommodate higher throughput.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of an imaging device that is configured scan media.

FIG. 2 is a first embodiment of an example scanning unit suitable for use in the device of FIG. 1.

FIG. 3 is a second embodiment of an example scanning unit suitable for use in the device of FIG. 1.

FIG. 4 is a flow diagram of an embodiment of a method for scanning media.

### DETAILED DESCRIPTION

As described above, current processes for processing scanned image data have attendant disadvantages. As described in the following, however, such processing can be performed on preview images captured using a dedicated preview image sensor that is adapted to capture relatively low-resolution images. In such a case, faster processing, and therefore scanning in general, can be achieved.

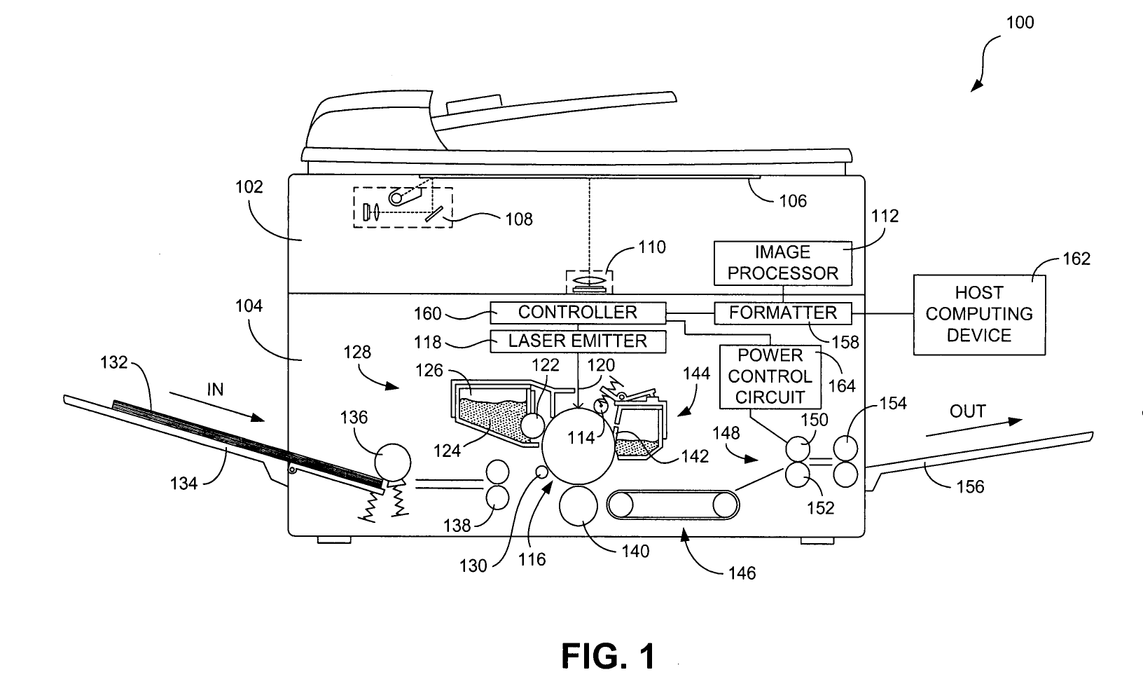

Referring to the drawings, in which like numerals indicate corresponding parts throughout the several views, FIG. 1 illustrates a schematic view of an example imaging device 100. The imaging device 100 is at least capable of scanning media. In addition, however, the device 100 may be capable of other functionalities such as printing and/or transmitting electronic image files. Therefore, the device 100 may comprise, for instance, a scanner, a scanner/printer (i.e., a photocopier), or a multifunction peripheral (MFP) that has various capabilities such as one or more of scanning, copying, printing, emailing, and faxing.

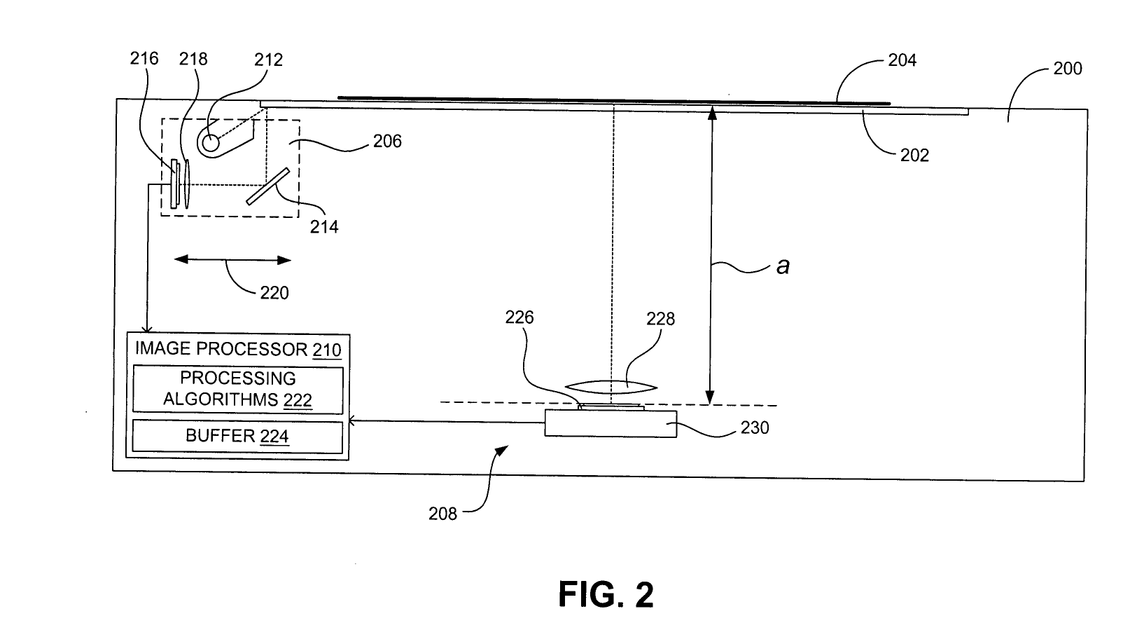

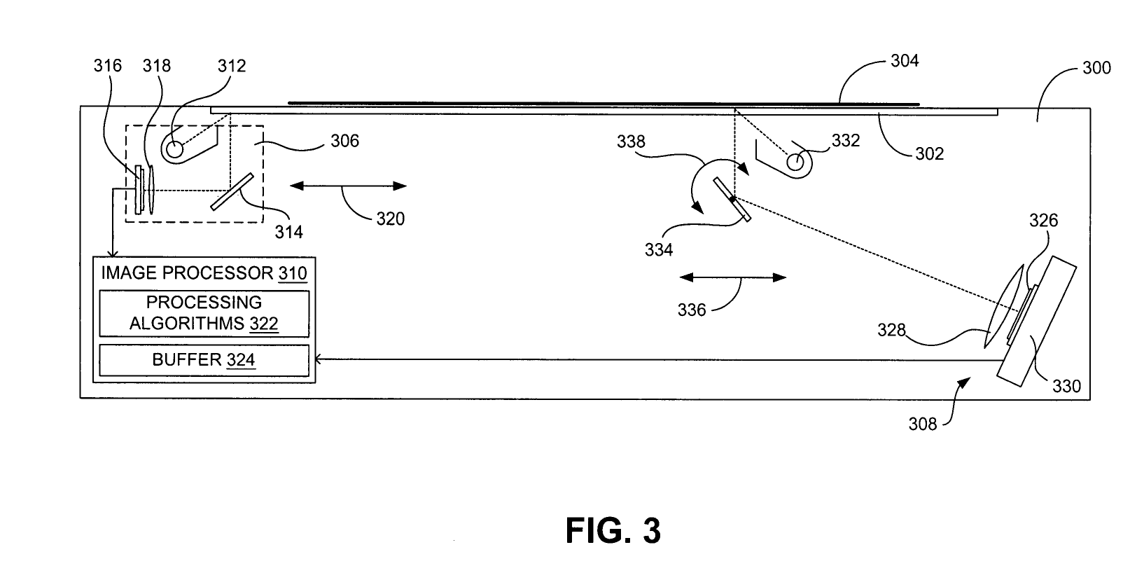

As indicated in FIG. 1, the example imaging device 100 comprises a scanning unit 102, which is responsible for scanning media, and a printing unit 104, which is responsible for generating hard copy documents. The scanning unit 102 comprises a platen 106 on which media to be scanned may be positioned, a final scanning module 108 that is used for final, high-resolution scanning, and a dedicated preview scanning module 110 that is used for capturing relatively low-resolution preview images for the purpose of performing image pre-processing. Example embodiments for the scanning modules 108 and 110 are described below in relation to FIGS. 2 and 3. In addition to the above-identified components, the scanning unit 102 further comprises an image processor 112 that is used to process captured image data.

The printing unit 104 comprises the various components used to generate hard copy documents. Therefore, the printing unit 104 comprises the print mechanism of the imaging device 100. The print mechanism includes a charging apparatus 114, such as a charge roller, that is used to charge the surface of a photoconductor member (e.g., drum) 116 to a predetermined voltage. By way of example, the photoconductor member 116 comprises an organic photoconductor (OPC). A laser diode (not shown) is provided within a laser emitter 118 that emits a laser beam 120 that is pulsed on and off as it is swept across the surface of the photoconductor member 116 to selectively discharge the surface of the photoconductor member. In the orientation shown in FIG. 1, the photoconductor member 116 rotates in the counterclockwise direction. A developing roller 122 is used to develop a latent electrostatic image residing on the surface of photoconductor member 116 after the surface voltage of the photoconductor member has been selectively discharged. The developing roller 122 develops the image using toner 124 that is, for example, stored in a toner reservoir 126 of an electrophotographic print cartridge 128.

The developing roller 122 can, for instance, include an internal magnet (not shown) that magnetically attracts the toner 124 from the print cartridge 128 to the surface of the developing roller. As the developing roller 122 rotates (clockwise in FIG. 1), the toner 124 is attracted to the surface of the developing roller and is then transferred across a gap between the surface of the photoconductor member 116 and the surface of the developing roller to develop the latent electrostatic image. Optionally, the print mechanism includes an erasing apparatus, such as an erase lamp 130, that is used to erase at least a portion of the latent electrostatic charge on the surface of the photoconductor member 116 after transfer of the toner to a recording medium.

Recording media 132, for instance sheets of paper, are loaded from an input tray 134 by a pickup roller 136 into a conveyance path of the device 100. Each recording medium 134 is individually drawn through the device 100 along the conveyance path by drive rollers 138 such that the leading edge of each recording medium is synchronized with the rotation of the region on the surface of the photoconductor member 116 that comprises the developed toner image. As the photoconductor member 116 rotates, the toner adhered to the member contacts the recording medium 132, which has been charged by a transfer roller 140, such that the toner particles are moved away from the surface of the photoconductor member and onto the surface of the medium. Typically, the transfer of toner particles from the surface of the photoconductor member 116 to the surface of the recording medium 132 is not completely efficient. Therefore, if toner particles remain on the surface of the photoconductor member 116, those toner particles are removed by a cleaning blade 142 and deposited in a toner waste hopper 144. As the recording medium 132 moves along the conveyance path past the photoconductor member 106, a conveyer 146 may deliver the recording medium to a fusing system 148 that, for example, comprises a fuser roller 150 and a pressure roller 152 that apply heat and pressure to the recording medium 132 so as to fuse the toner to the surface of the recording medium. After fusing is completed, output rollers 154 draw the recording medium 132 out of the fusing system 148 and deliver the medium to an output tray 156.

As identified in FIG. 1, the imaging device 100 further includes a formatter 158 and an imaging device controller 160. The formatter 158 acts as an image processor and therefore receives data (e.g., transmitted from a host computing device 162 or received from the image processor 112) and converts the data into a stream of print data that is sent to the controller 160. The formatter 158 and the controller 160 exchange data necessary for controlling the printing process, and the controller supplies the stream of print data to the laser emitter 118. The print data stream sent to the laser diode within the laser emitter 118 pulses the laser diode to create the latent electrostatic image on the photoconductor member 116.

In addition to providing the print data stream to the laser emitter 118, the controller 160 controls a high voltage power supply (not shown) that supplies voltages and currents to the components used in the device 100 including the charge apparatus 114, the developing roller 122, and the transfer roller 140. The controller 160 further controls a drive motor (not shown) that drives the printer gear train (not shown) as well as the various clutches and feed rollers (not shown) necessary to move recording media 132 through the conveyance path of the device 100. A power control circuit 164 controls the application of power to the fusing system 148. Although the imaging device 100 has been described as comprising a laser print mechanism, the device can, alternatively, comprise an ink jet print mechanism.

FIG. 2 is a schematic view of a first embodiment of a scanning unit 200 that is suitable for use in the imaging device 100 of FIG. 1. As indicated in FIG. 2, the scanning unit 200 comprises a platen 202, such as a piece of glass, on which media, such as a piece of paper 204, may be placed for purposes of scanning. The scanning unit 200 further comprises a final scanning module 206 that is used for final, high-resolution scanning, and a dedicated preview scanning module 208 that is used for capturing relatively low-resolution preview images at least for the purpose of performing image pre-processing. As shown in the figure, each of these modules 206, 208 are in communication with an image processor 210.

The final scanning module 206 comprises a light source 212, such as an illumination lamp, that is used to expose the media placed on the platen to facilitate image capture. The light reflected off of the media may be reflected by a reflector 214, such as a mirror, to a high-resolution image sensor 216. By way of example, the image sensor 216 comprises a linear photosensor array such as a liner charge-coupled device (CCD) having a resolution in the range of approximately 600-1200 points per inch (ppi). In the embodiment of FIG. 2, an optical system 218 (represented by a single lens) is interposed between the reflector 214 and the image sensor 216 to focus light, and therefore reflected images, on the image sensor. As is depicted by directional arrow 220, the scanning module 204 is configured to travel along the length of the platen 202 (or a portion thereof where appropriate) to scan media placed on the platen (e.g., the piece of paper 204). Such movement is accomplished through use of one or more motors (not shown) that displace the scanning module 204 at a constant rate directly underneath the platen 202.

The image data collected by the image sensor 216 is provided to the image processor 210. The image processor 210 may comprise a microprocessor or an application specific integrated circuit (ASIC) that is specifically designed to perform various image processing and to store and/or transmit image data. In the embodiment of FIG. 2, the image processor 210 comprises internal memory that stores processing algorithms 222, and which includes a buffer 224 that is used to temporarily store collected image data for purposes of conducting image processing.

Similar to the final scanning module 204, the dedicated preview scanning module 208 comprises an image sensor 226 and an associated optical system 228 (represented by a single lens). The image sensor 226 and the optical system 228 can, optionally, be mounted to a base or carriage 230. In some embodiments, the scanning module 208, and therefore its image sensor 226 and optical system 228, is fixed in place within the scanning unit 200. Such an arrangement may be desirable in that media placed on the platen 202 can be captured (i.e., scanned) quickly without the latency associated with physically moving an image sensor back and forth. In some cases, the image sensor 226 can capture an image of the platen 202 (and the media placed thereon) in similar manner to taking a picture using a digital camera. In such a case, all image data is captured at substantially the same time. Notably, use of a wide angle lens in the optical system 228 may facilitate such instantaneous image capture. In other embodiments, however, the scanning module 208 may be laterally or axially displaceable for purposes of enabling scanning of the entire platen 202 in cases in which such scanning is not possible using a fixed image sensor. As with the image sensor 216 of the final scanning module 204, the image sensor 226 of the preview scanning module 208 is in communication with the image processor 210 so that image data captured by the image sensor 226 may be provided to the processor. In the case of the image sensor 226, however, pre-processing (described below) is performed on a preview image prior to final scanning of the media.

The image sensor 226 may comprise a two-dimensional photosensor array (e.g., two-dimensional CCD), or a linear photosensor array (e.g., linear CCD) in cases in which the sensor is laterally and/or axially translated to enable scanning of the entire platen 202. To obtain relatively-low resolution images for purposes of conducting the pre-processing, the image sensor 226 has a relatively low-resolution as compared to the image sensor 216 of the final scanning module 204. By way of example, the image sensor 226 has a resolution in the range of approximately 30-150 ppi, with 30-75 ppi being satisfactory in some embodiments. Optionally, the resolution of the captured preview image can vary, for example, if the optical characteristics are different for a document placed on the platen by a user versus a document fed through an automatic document feeder (ADF). Furthermore, the resolution of the image sensor 226 is selected so as to comprise a multiple of the resolution of the image sensor 216 of the final scanning module 204 for purposes of convenient scaling. Therefore, if the image sensor 216 has a resolution of 600 ppi, the image sensor 226 could have a resolution of 75 ppi (i.e., ⅛ of 600 ppi). Such an arrangement reduces the amount of data collected by a factor of 1/64 and results in two orders of magnitude reduction in processing time. Notably, because of the relatively-low resolution of the image sensor 226, inclusion of the sensor does not add appreciably to the total manufacturing costs of the imaging device 100. This is particularly the case in situations in which a stationary image sensor can be used to capture the entire platen 202 because no additional hardware may be necessary to perform the preview scan.

As is further indicated in FIG. 2, the image sensor 226 of the preview scanning module 208 is positioned directly opposite the platen so that the sensor directly faces the platen and is spaced a distance, a, from the platen 202 or the media (e.g., piece of paper 204). This distance may, in some cases, be approximately equal to the focal length, f, of the optical system 228.

FIG. 3 is a schematic view of a second embodiment of a scanning unit 300 that is suitable for use in the imaging device 100 of FIG. 1. As indicated in FIG. 3, the scanning unit 300 is similar in construction to the scanning unit 200 shown in FIG. 2. Accordingly, the scanning unit 300 comprises a platen 302 on which media, such as a piece of paper 304, may be placed, a final scanning module 306, a dedicated preview scanning module 308, and an image processor 310. The final scanning module 306 may again comprise a light source 312, a reflector 314, a high-resolution image sensor 316, and an optical system 318, and may be laterally displaceable, as indicated by directional arrow 320. The image processor 310 may again comprise processing algorithms 322 and a buffer 324. Furthermore, the dedicated preview scanning module 308 may comprise an image sensor 326, an optical system 328, and a base or carriage 330. However, unlike as with the scanning unit 200 of FIG. 2, the dedicated preview scanning module 308 is positioned in a non-perpendicular position relative to the platen 302. For example, as indicated in FIG. 3, the scanning module 308 may be placed in a corner of the scanning unit 300 at an angle (e.g., 45 degree angle relative to vertical) to facilitate its inclusion within the unit in situations in which space is limited.

Because of the angled configuration of the preview scanning module 308, additional elements may be necessary to achieve scanning of the entire platen 302. For example, as indicated in FIG. 3, an additional light source 332 and reflector 334 may be used to ensure light reflected from all parts of the media (e.g., piece of paper 304) are provided to the image sensor 326. In such a case, the light source 332 and reflector 334 may be laterally displaceable, as indicated by directional arrow 336, and the reflector may further be axially rotatable, as indicated by directional arrow 338. In alternative embodiments, however, other means may be used to provide reflected light to the image sensor 326. For example, the light source 312 and reflector 314 of the final scanning module 306 may be leveraged to deliver image data to the image sensor 326. In other embodiments, the scanning module 308 may also be laterally and/or axially displaceable. Furthermore, additional and/or alternative reflectors and/or lenses may be used to ensure delivery of light to the image sensor 326. Irrespective of the scheme used to deliver the reflected light to the image sensor 326, the sensor has a relatively low resolution as compared to the image sensor 316 of the final scanning module 306 to facilitate rapid pre-processing.

As is apparent from FIG. 3, the light path between the platen 302 and the image sensor 326 may not be direct. Regardless, that light path may also be approximately equal to the focal length, f, of the optical system 328. In other embodiments, however, the length of the light path may be other than the optical system focal length. For example, if a Scheimpflug and Hinge optical arrangement, or other known optical arrangement, is implemented in the scanning unit 300 the light path length may be different from, but equivalent to from an optics perspective, the optical system focal length, f.

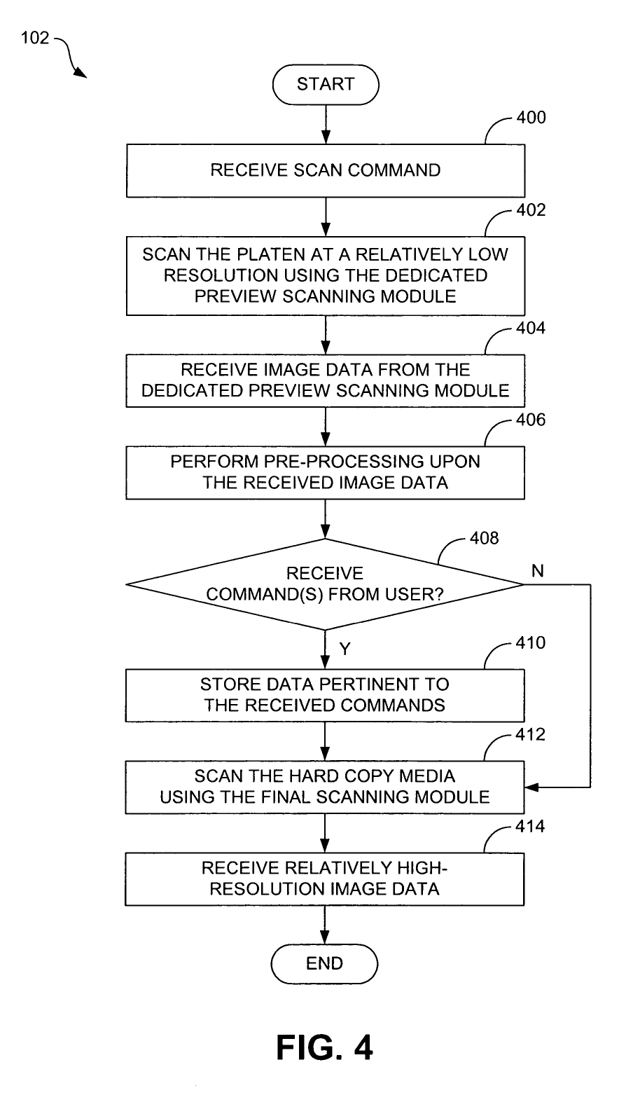

An example method for scanning media using a system described above is provided in the flow diagram of FIG. 4. Process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently, depending on the functionality involved.

Beginning with block 400 of FIG. 4, the imaging device 100, and more particularly the scanning unit 102 of the device, receives a scan command. This command can have been registered by direct entry of a scan command by a user (e.g., in a control panel of the imaging device 100 or via a communication transmitted from the user's computing device (e.g., personal computer (PC)). Irrespective of the manner in which the scan command was received, the scanning process begins by scanning the device platen at a relatively low resolution using the dedicated preview scanning module 110. The manner in which this scanning (i.e. preview scanning) is accomplished depends upon the specific arrangement of the scanning unit 102 and its associated preview scanning module 110.

Specific embodiments for the preview scanning module 110 have been described in relation to FIGS. 2 and 3 above. In an embodiment such as that shown in FIG. 2 in which an optionally fixed preview scanning module is positioned opposite the device platen, the preview scanning may simply comprise capturing image data representative of the entire, or nearly the entire, platen at substantially the same time in similar manner to taking a picture with a digital camera. In an embodiment such as that shown in FIG. 3 in which an angled preview scanning module is provided within the scanning unit 102, preview scanning may comprise manipulation and translation of a light source and/or an associated reflector to provide reflected light to the image sensor of the preview scanning module.

With reference next to block 404, the image data collected by the dedicated preview scanning module 110 is received, for instance by the image processor 112. At this point, the various pre-processing that is to be performed can be conducted, as indicated in block 406. The pre-processing comprises any processing that is needed to automatically determine one or more settings to be applied when finally scanning the media. For example, the pre-processing may pertain to one or more of automatic copy type detection (black and white versus color), automatic document size detection, automatic skew detection, zoning analysis, background/foreground determination, document classification, template (foreground and/or background) matching, an ink requirement, and the like. Because the media has been scanned at relatively low resolution (e.g., 30-150 ppi), the amount of data to pre-process is relatively small, thereby significantly reducing the amount of time required to complete that pre-processing.

In addition to the information obtained after conducting the aforementioned pre-processing, commands pertinent to the final scanning may be provided by the user. For example, the user may wish to crop the image to be captured to exclude certain portions of content (e.g., portions of a photograph). In addition, the user may specify a particular resolution at which to complete the final scanning. Notably, the user's determination to input such commands may, in some embodiments, be made after the user views the preview image (e.g., on the user's PC or with a display associated with the imaging device 100).

With reference to decision block 408, it is determined whether any such user commands have been received. If not, flow continues down to block 412 described below. If so, however, flow continues to block 410 at which the image device 100, and more particularly the image processor 112 of the device, stores data pertinent to the received command(s).

At this point, all data pertinent to performing the final scanning of the media has been received. Therefore, by way of example, all information related to the copy type, document size, document skew, document zones, cropping, scanning resolution, etc. has been received and may be applied when, as indicated in block 412, the media is scanned using the final scanning module 108. Because the final scanning module 108 comprises a high-resolution image sensor, the scanned image will typically have a resolution higher than that of the preview image (even if the user selected a relatively low resolution for the final scan). Regardless, the scanning is conducted relative to any information obtained from the pre-processing (block 406) and/or to the command(s) received from a user (block 410).

As the final scanning is performed (or thereafter), relatively high-resolution image data is received by the image processor 112, as indicated in block 414. At this point, any further actions desired by the user may be performed. For instance, if the imaging device 100 comprises a printing unit 104, the image processor 112 may provide the received image data to the formatter 158 for the purpose of generating one or more hard copy documents that comprise the image data. Alternatively, the image data collected by the image processor 112 can be transmitted to a user PC for viewing and/or storage. In yet another alternative, the image data may be transmitted via email or a facsimile transmission to a desired recipient.

Scanning in the manner described in relation to FIG. 4 presents several advantages not achievable with most known scanning systems. Most notably, a relatively low-resolution image may be obtained more quickly that in known systems, particularly in cases in which a fixed preview image sensor is used to capture an area equal to or nearly equal to the entire device platen. This is particularly the case when no scaling, buffering, or interpolating is necessary (as is in present solutions). This results in faster scanning of hard copy print media and, therefore, greater user satisfaction. Alternatively, the time saved in conducting the preview scanning can be utilized to perform higher quality final scanning of the media, or may enable the use of a slower, and therefore lower cost, image sensor to conduct the final scanning. Furthermore, in cases in which the dedicated preview scanning module is fixed within the scanning unit, a more simple, and therefore reliable, scanning solution is obtained with less opportunity for mechanical failure.

1. A method for scanning media, the method comprising:
scanning a platen using a dedicated preview image sensor; and
pre-processing image data obtained through the scanning of the platen to automatically determine settings to apply during a subsequent final scan.

2. The method of claim 1, wherein scanning a platen comprises scanning the platen using a dedicated preview image sensor having a resolution of approximately 30-150 pixels per inch (ppi).

3. The method of claim 1, wherein scanning a platen comprises scanning the platen using a dedicated preview image sensor that is fixed within a scanning unit of an imaging device.

4. The method of claim 1, wherein scanning a platen comprises capturing an image of the entire media using the dedicated preview image sensor instantaneously.

5. The method of claim 1, wherein pre-processing comprises at least one of performing automatic copy type detection, automatic document size detection, automatic skew detection, zoning analysis, background/foreground determination, document classification, template matching, and an ink requirement estimate.

6. The method of claim 1, further comprising scanning the media at a relatively high resolution using a high-resolution image sensor that is separate from the dedicated preview image sensor.

7. The method of claim 6, wherein scanning the media at a relatively high resolution comprises scanning the media using at least one setting that was determined through the pre-processing.

8. A system for scanning media, the system comprising:
dedicated means for preview scanning;
means for pre-processing image data obtained from the means for preview scanning;
means for determining settings to apply during a final scan; and
means for final scanning the media.

9. The system of claim 8, wherein the means for preview scanning comprise a dedicated preview image sensor.

10. The system of claim 9, wherein the dedicated preview image sensor has a resolution of approximately 30-150 pixels per inch (ppi).

11. The system of claim 9, wherein the dedicated preview image sensor is fixed within a scanning unit of an imaging device.

12. The system of claim 9, wherein the dedicated preview image sensor is configured to capture an image of the media instantaneously.

13. The system of claim 8, wherein the means for pre-processing comprises an image processor of a scanning unit.

14. The system of claim 13, wherein the image processor is configured to perform at least one of automatic copy type detection, automatic document size detection, automatic skew detection, zoning analysis, background/foreground determination, document classification, template matching, and an ink requirement estimate.

15. The system of claim 8, wherein the means for final scanning comprise a high-resolution image sensor.

16. The system of claim 8, wherein the means for preview scanning comprise a dedicated preview image sensor having a resolution of approximately 75 points per inch (ppi) and the means for final scanning the media comprise a high-resolution image sensor having a resolution of approximately 600 ppi.

17. A scanning unit for use in an imaging device, comprising:
a dedicated preview scanning module comprising a first image sensor having a first resolution;
a final scanning module comprising a second image sensor having a second resolution that is higher than the first resolution; and
an image processor that is configured to pre-process image data collected by the dedicated preview scanning module to determine settings to be used to operate the final scanning module.

18. The scanning unit of claim 17, wherein the dedicated preview scanning module is fixed within the scanning unit so as not to be movable within the unit.

19. The scanning unit of claim 17, wherein the dedicated scanning module is displaceable to facilitate scanning.

20. The scanning unit of claim 17, further comprising a platen on which media may be placed, wherein the dedicated preview scanning module is positioned directly opposite the platen such that the first image sensor directly faces the platen.

21. The scanning unit of claim 17, further comprising a platen on which media may be placed, wherein the dedicated preview scanning module is positioned at an angle relative to the platen such that the first image sensor does not directly face the platen.

22. The scanning unit of claim 17, wherein the dedicated preview scanning module further comprises a wide angle lens.

23. The scanning unit of claim 17, wherein the image processor comprises at least one processing algorithm and a buffer.

24. The scanning unit of claim 17, further comprising a light source that is configured to facilitate delivery of reflected light to the first image sensor of the dedicated preview scanning module.

25. The scanning unit of claim 24, further comprising a reflector that is configured to facilitate delivery of reflected light to the first image sensor of the dedicated preview scanning module.

26. The scanning unit of claim 17, wherein first image sensor has a resolution of approximately 75 points per inch (ppi) and the second image sensor has a resolution of approximately 600 ppi.

27. An imaging device, comprising:
a scanning unit including a dedicated preview scanning module, a final scanning module, and an image processor that is configured to pre-process image data collected by the dedicated preview scanning module to determine settings to be used to operate the final scanning module; and
a printing module that is configured to generate hard copy documents from received image data.

28. The imaging device of claim 27, wherein the dedicated preview scanning module comprises a low-resolution image sensor.

29. The scanning unit of claim 28, wherein low-resolution image sensor has a resolution of approximately 75 points per inch (ppi).

30. The imaging device of claim 28, wherein the dedicated preview scanning module is fixed within the scanning unit.

31. The imaging device of claim 27, wherein the final scanning module comprises a high-resolution image sensor.

32. The imaging device of claim 31, wherein the high-resolution image sensor has a resolution of approximately 600 points per inch (ppi).

33. The imaging device of claim 27, further comprising a platen on which media may be placed, wherein the dedicated preview scanning module is positioned directly opposite the platen such an image sensor of the dedicated preview scanning module directly faces the platen.

34. The imaging device of claim 27, further comprising a platen on which media may be placed, wherein the dedicated preview scanning module is positioned at an angle relative to the platen such that an image sensor of the dedicated preview scanning module does not directly face the platen.
